(19) United States
(12) Patent Application Publication
(10) Pub. No.: US 2019/0306159 A1
(43) Pub. Date: Oct. 3, 2019

(54) TIME-BASED ONE-TIME PASSWORD FOR DEVICE IDENTIFICATION ACROSS DIFFERENT APPLICATIONS

(71) Applicant: CA, Inc., New York, NY (US)

(72) Inventors: Gaurav AGARWAL, Bangalore (IN); Alok GUPTA, Bangalore (IN); Siddhartha GHOSH, Bangalore (IN); Rahul Gurudas DHAVALIKAR, Bangalore (IN)

(73) Assignee: CA, Inc.

(21) Appl. No.: 15/936,573

(22) Filed: Mar. 27, 2018

(51) Int. Cl. H04L 29/06; H04L 9/32

(52) U.S. Cl. CPC H04L 63/0846; H04L 63/0838; G06Q 20/40; H04L 9/3228; H04L 9/321; H04L 63/0876

(57) ABSTRACT

A method is described for receiving, at a server, an authorization request from a first application stored on a user device, the first application being associated with a third party, wherein the authorization request comprises a time-based one-time password. The method further includes determining whether the time-based one-time password is associated with a time-based one-time password provision previously transmitted to a second application stored on the user device, wherein the second application is associated with an account of a user of the user device. The method further includes authorizing a transaction between the account of the user and the third-party, in response to determining that the time-based one-time password is associated with the time-based one-time password provision.

### BACKGROUND

The present invention relates generally to authentication, and more specifically to a time-based one-time password for device identification across different applications.

### SUMMARY

A method is described for receiving, at a server, an authorization request from a first application stored on a user device, the first application being associated with a third party, wherein the authorization request comprises a time-based one-time password. The method further includes determining whether the time-based one-time password is associated with a time-based one-time password provision previously transmitted to a second application stored on the user device, wherein the second application is associated with an account of a user of the user device. The method further includes authorizing a transaction between the account of the user and the third-party, in response to determining that the time-based one-time password is associated with the time-based one-time password provision.

### BRIEF DESCRIPTION OF THE DRAWINGS

Aspects of the present disclosure are illustrated by way of example and are not limited by the accompanying drawings.

FIG. 1A illustrates an authorization ecosystem in a non-limiting embodiment of the present disclosure.

FIG. 1B illustrates systems within an authorization ecosystem in a non-limiting embodiment of the present disclosure.

FIG. 2 is a flowchart of initial operations and information flows that may be performed by an authorization system of a non-limiting embodiment of the present disclosure.

FIG. 3 is a flowchart of operations and information flows that may be performed by an authorization system of a non-limiting embodiment of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Authentication, particularly user authentication, is widely used by all types of service. The broad range of applications that require user authentication include online banking, email services, online shopping, smart home applications, chat services and gaming. Traditionally, user authentication is provided by the application or entity that is providing that service, like an email server which validates a user logon in order to access the user's email. With increasing frequency, third-party authentication is used for applications to operate or complete transactions. In a particular embodiment, shopping applications may pass credentials and transaction details to a bank to validate the user and complete a purchase.

In validating a user's transaction, applications may use user device identification to assess the risk of a given transaction. The validating entity may use the user's device identification to check if a device is a known device, if the user is associated with the device, or if the user has used the device in the past. Device identification can play a key role in assessing the risk of a given transaction. Further, in validating a user's transaction, applications may verify not only the authenticity of the device, but also identify a particular device of a user. Identifying not only the user and the user's device, but the particular device of the user, may allow the system to provide device specific risk assessment as required by the system.

Applications often use cookies or browser signatures for user device identification. In the case of mobile applications, user device identification may be difficult to accomplish in a manner that is reliable and spoof-proof due at least in part to operating system restrictions on reliable device identification.

The present disclosure describes an authentication system that permits the authentication of a user device in addition to the traditional credentials used by the authentication system. More particularly, the present disclosure describes an authentication system that uses a time-based one-time password (TOTP) that allows user device authentication across different applications.

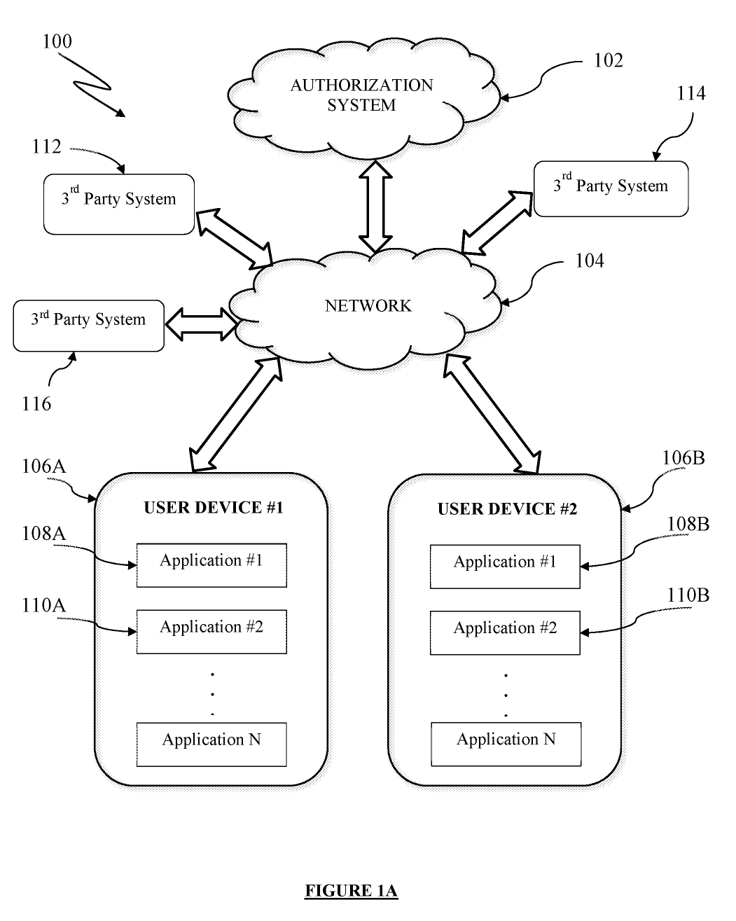

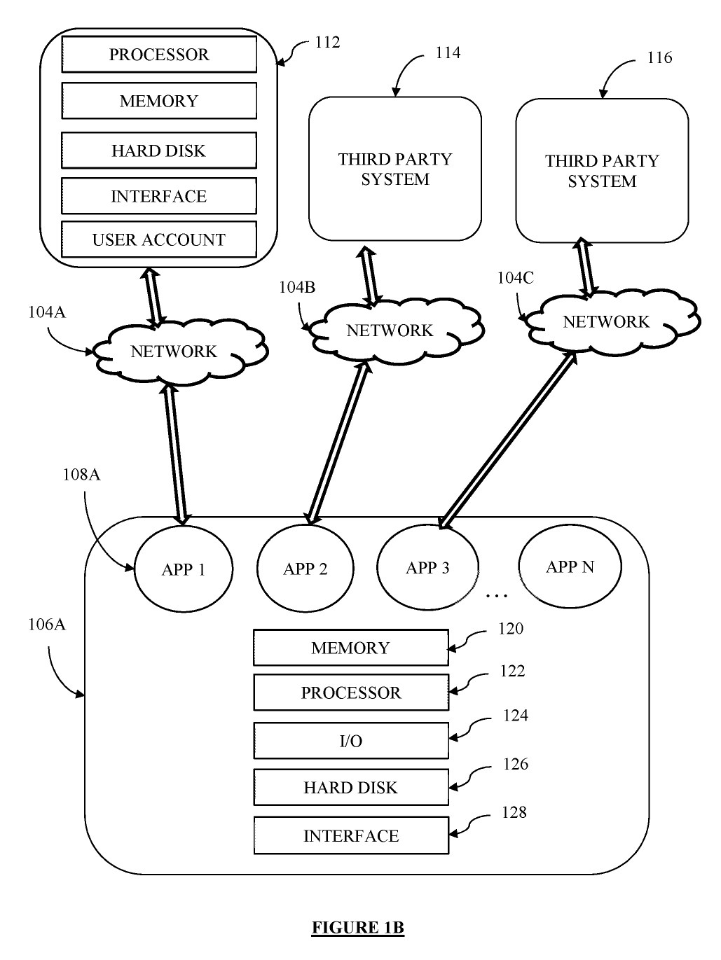

FIG. 1A illustrates an authorization ecosystem 100 in a non-limiting embodiment of the present disclosure. An authorization ecosystem 100 may include an authorization system 102, network 104, user devices 106A and 106B, and user applications 108A, 110A, 108B, 110B, and third-party systems 112-116.

The authorization system 102 may comprise one or more entities which provide the central function of authorizing a transaction within the authorization ecosystem 100. An authorization system 102 may be used for authorizing, among other things, financial transactions, private access to data or networks, or device access (e.g. in a smart home system). The authorization system 102 is connected via the network 104 to the user device and user applications. The authorization system 102 may comprise many different entities that provide a portion of the authorization, or in a distributed computing system.

The authorization system 102 may be located on the cloud or on an external network. In some non-limiting embodiments, the authorization system 102 may be partially located on a mobile device and partially on the cloud or a network, or any combination thereof. Furthermore, some non-limiting configurations of the authorization system 102 may be located exclusively on a user's device 106A. The authorization system 102 may also be accessed by the user on a device 106A. The user device 106A may be any type of computing device, such as, for example, a mobile telephone.

Network 104 may comprise one or more entities, which may be public, private, or community based. Network 104 may permit the exchange of information and services among users/entities that are connected to such network 104. In certain configurations, network 104 may be a local area network, such as an intranet. Further, network 104 may be a closed and/or private network/cloud in certain configurations, and an open network/cloud in other configurations. Network 104 may facilitate wired or wireless communications of information and provisioning of services among users that are connected to network 104.

The user devices 106A and 106B may comprise many different types of devices. Some examples include computers, laptops, mobile devices, and wearable computing devices. The user device 106A may be connected to the network 104, at least at the time of conducting the transactions described herein. Each user may have multiple devices, however transaction authorization within the authentication ecosystem 100 may be device dependent. Thus, in a particular embodiment, a transaction conducted on device 106A using application 108A cannot be authenticated by a second application 110B on another device 106B.

Each user device 106A may have many applications, such as 108A and 110A. These applications traditionally provide some sort of functionality to the user on the user device, such as banking, email, shopping, home control, and entertainment applications. These applications can communicate with other applications on the user device 106A, other user devices, or with the other entities on the network, such as the authorization system 102.

FIG. 1B illustrates systems within an authorization ecosystem 100 in a non-limiting embodiment of the present disclosure. The systems depicted include the network 104A-104C, user device 106A, and third-party systems 112-116.

The network 104 may comprise many interconnected, or separate, individual networks 104A-104C. In some embodiments, the individual networks 104A-C may be private networks, local networks, or over-the-air networks (e.g., a WiFi network, Bluetooth network, NFC network, RF network, RFID network).

The user device 106A may include several hardware components necessary to facilitate use by the user, and communication with other systems. The user device 106A may include local memory 120, a processor 122, a variety of I/O devices 124, a hard disk and/or other non-volatile memory 126, and/or an interface 128. The user device 106A may also include a plurality of applications 108A.

The third-party systems 112-116 may take many forms depending on the role and location of the third-party system. As depicted in FIG. 1B, the third-party systems may be connected to the user device 106A through individual or interconnected networks 104A-104C. In some embodiments, the third-party systems may provide the user some service through an application 108A on the user device 106A. In these embodiments, in order to provide those services, the third-party systems may include some essential hardware to facilitate both the communication with the application 108A on user device 106A, and some user transaction authentication mechanism. In these embodiments, the third-party systems 112-116 will include at least a user account associated with the user of the user device 106A.

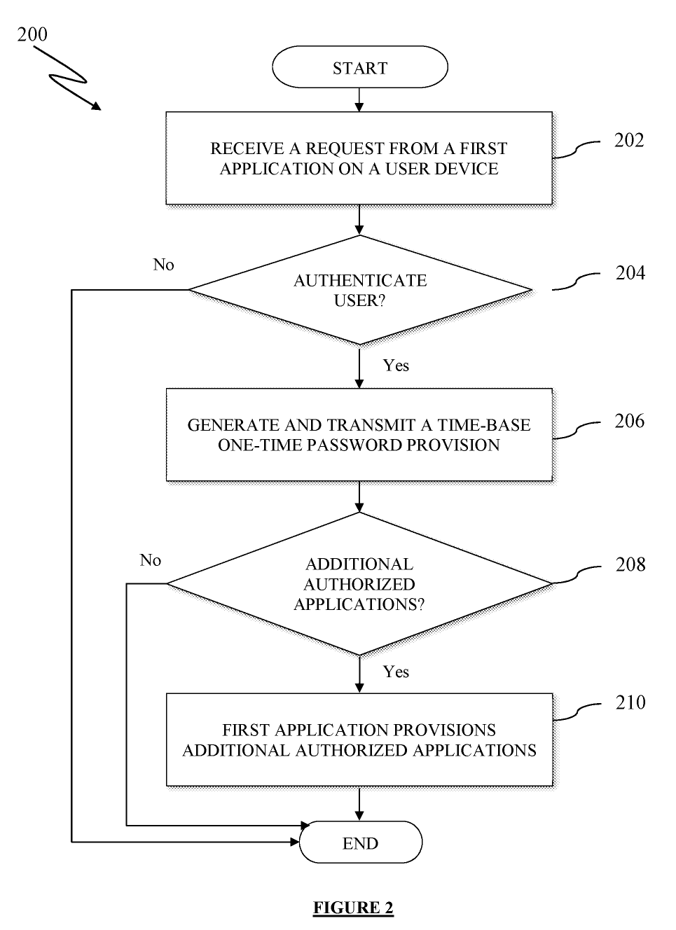

FIG. 2 is a flowchart of initial operations and information flows that may be performed by the authorization system 102 according to a non-limiting embodiment of the present disclosure. The initial provisioning activity 200 begins with step 202, where the authorization system 102 receives an initial request from the first application 108A on the user device 106A to authenticate a user for the first time on user device 106A. This request may be generated by the first application 108A in response to a user logging into that application. In accordance with one embodiment, the request is generated in response to the user logging in for the first time on the user device 106A. In accordance with another embodiment, the user may be prompted to authorize the sending of the request in response to: downloading or installing the first application 108A; using the first application 108A; or opening a new account associated with the first application 108A.

In step 204, the authorization server 102 validates the user's credentials. The user's credentials may comprise identifying information along with information or data known or accessible only to the user. For example, the user's credentials may include a username and password. In other embodiments, the user's credentials may include biometric information, PIN number, bank card, encrypted keys, generated token, voice recognition, image identification, or any other form of multi-factor authentication.

After validating the user's credentials, the authorization server 102 may generate a time-based one-time password provision. The TOTP provision may be a key that is generated and may uniquely identify the user and the user device. In some embodiments, the TOTP provision may only uniquely identify the user or the user device.

In a particular embodiment, the TOTP provision may be a hashed shared secret key. In other embodiments, the TOTP provision may be any generated string or value that is unique and can be used by the authorization system to associate a TOTP with the first application 108A of the user device 106A. A TOTP can be generated by combining the TOTP provision, the current time, and a time interval using various methods. First, the current timestamp may be converted into an integer time counter by subtracting the current timestamp from a known point in time (e.g., Unix epoch) and dividing the result by a time interval and rounding down. The time interval may be determined by the authorization server 102 and provided as part of the TOTP provision to the first application 108A. The time interval represents a period of time during which a given TOTP is valid. After the time interval has passed, the integer time counter increments. Thus, the time interval is often set for shorter time periods. In a particular embodiment, the time interval may be set to thirty seconds. In other embodiments, the time interval may be set anywhere from a few minutes (e.g., 2 minutes, 5 minutes) to a few seconds (e.g., 5 seconds, 10 second, 30 seconds). The TOTP provision may be limited with respect to time (e.g., days, weeks, months) or it may be valid indefinitely. While the TOTP provision may last for a longer period of time, the TOTP generated using the TOTP provision will only be valid for a shorter period of time (e.g., seconds or minutes) based on the time interval. For example, in a particular embodiment, the TOTP may be valid for one minute or less (e.g., thirty seconds). The short lifespan of the generated password is one advantage of using a TOTP authentication system, providing additional security over traditional authentication mechanisms.

In another embodiment, the TOTP provision may be used along with the integer time counter to generate the TOTP. In a particular embodiment, the TOTP provision is combined with the integer time counter using a cryptographic secured hash function (e.g., SHA-1, SHA-256) to generate a TOTP. The secured hash function may take the integer time counter, concatenate it with the secured hash of the TOTP provision XOR with a predetermined value. This result can be concatenated again with the TOTP provision XOR with a different predetermined value, and hashed again to generate the TOTP. The TOTP that is generated may not be able to be decoded. Rather, in order to validate a generated TOTP, an entity may generate its own TOTP using the same information used to generate the original TOTP. The entity may then compare the original TOTP with its own generated TOTP to determine if the two are a match.

After generating the TOTP provision, the authorization server, in step 206, sends a response to the first application 108A on user device 106A authenticating the user and supplying the time-based one-time password provision.

In some embodiments, steps 202-206 are all that is performed by the authorization system 102 in initial provisioning activity 200. In other embodiments, the initial provisioning activity 200 may include steps 208 and 210. In step 208, the user may use the first application 108A on user device 106A to authorize a plurality of other applications 110A on the user device 106A to use the TOTP device authentication method of the first application 108A. The user would typically interact with the first application 108A (e.g., through a graphical user interface) to select a plurality of other applications that may be stored on the user device. For example, the user may select or authorize a subset (e.g., a plurality, but fewer than all) of the applications 110A stored on the user device to have access to the TOTP provision and/or a TOTP generated by the TOTP provision. These other applications are then allowed to access an exposed interface of the first application 108A to obtain the generated TOTP when completing a transaction. In a particular embodiment, the first application 108A may store identifiers for each of the other applications 110A that have access to the exposed interface in order to limit access to the exposed interface to only the subset of applications that were authorized by the user.

In step 210, the first application 108A notifies each of the selected second applications 110A that they are authorized to request a TOTP from the first application 108A when completing a transaction. The plurality of second applications 110A may then adjust their transaction procedure to obtain the TOTP from the first application 108A before sending a transaction for authorization.

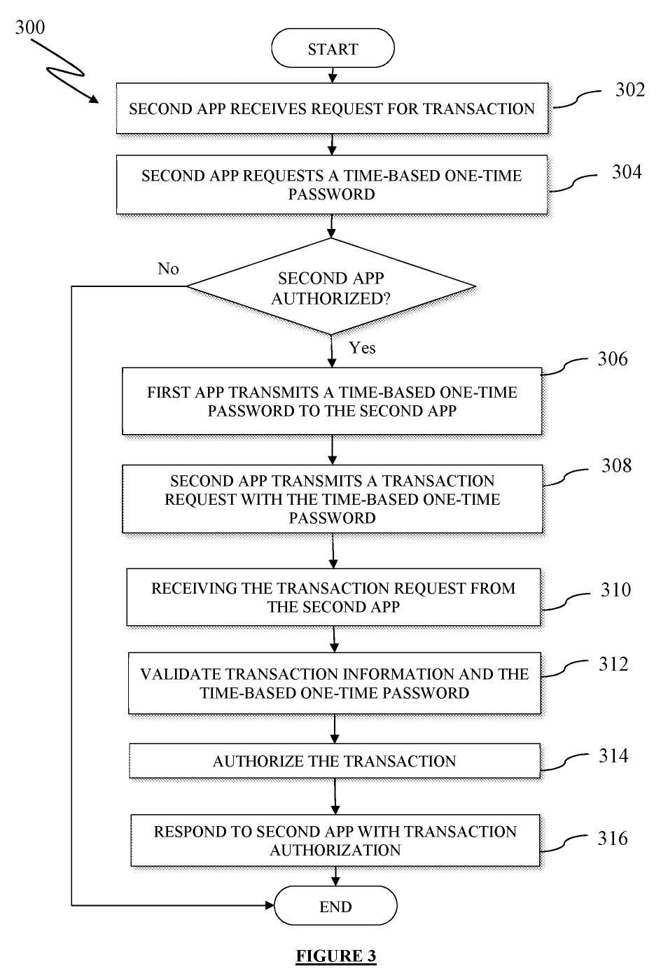

FIG. 3 is a flowchart of operations and information flows that may be performed by the authorization system 102 of a non-limiting embodiment of the present disclosure. The transaction authorization process 300 may be performed after the initial provisioning process 200 has been completed by the user on the user device 106A. The transaction authorization process 300 begins when the user is ready to complete a transaction in the second application 110A on the user device 106A.

When the user on user device 106A is ready to complete a transaction through a second application 110A, the second application 110A sends a request to an interface provided by the first application 108A on the user device 106A. In step 304, the request is sent from the second application 110A to the first application 108A on user device 106A to request a TOTP from the first application 108A to provide device authentication for the transaction.

In step 306, the first application 108A, upon receiving an interface request for a TOTP, validates that the second application 110A is allowed to retrieve a TOTP from the first application 108A by determining whether the second application 110A has been pre-authorized (e.g., by the user of the user device 106A). If the second application 110A is authorized to retrieve the TOTP from the first application 108A, the first application 108A will generate a TOTP using the TOTP provision provided by the authorization system 102 in step 206. The TOTP generated by the first application 108A is typically valid for a short period of time (e.g., thirty seconds after the password is generated). The generated TOTP will then be returned by the first application 108A to the second application 110A on the user device 106A. In using the approach in step 306, the user may not be made aware of the interface call from the second application 110A to the first application 108A during the completion of the transaction in the second application 110A. In some embodiments, the interface call may be hidden from the user. In other embodiments, the interface call is entirely transparent to the user.

One benefit of the second application 110A obtaining the TOTP from the first application 108A is that the authorization server 102 has the ability to uniquely identify the user device 106A that is making the transaction request. The initial provisioning of the first application 108A was authorized explicitly by the authorization server 102 and the TOTP provision provided to the first application 108A uniquely identifies at least the user device 106A, if not the user itself. The device identification provided through the transaction authorization process 300 may provide benefits over existing solutions. The device identification process may have one or more of the following advantages: being transparent to the user, requiring no additional user interaction beyond the initial provisioning process 200, decreasing risk of transaction fraud, and/or providing additional transaction security.

Alternatively, in step 306, the first application 108A, upon receiving an interface request for a TOTP from the second application 110A, may require the user to enter a PIN or other authentication method to verify the user of the user device 106A. Once the user has entered the PIN or other authentication method in the first application 108A, the first application will validate the user and return the TOTP to the second application 110A. This alternative approach does not have the transparency associated with the first approach of step 306, however it may provide additional security for the user's computing environment. For example, on a device that is used by multiple users, the additional step of providing the user's PIN associated with the first application 108A may be helpful to ensure the correct user is being provided a TOTP for a transaction authorization.

In step 308, the second application 110A receives the TOTP from the first application 108A and sends the transaction request for authorization and authentication to the authorization system 102. The second application 110A may send the authorization request directly to the authorization system 102. Alternatively, the second application 110A may send the authorization request via the network 104 to an intermediary, which forwards the request to the authorization system 102. The transaction request sent by the second application 110A comprises at least the details of the transaction, the user's transaction information (e.g. credit card number and security code), and the TOTP obtained from the first application 108A. The transaction request may be sent in an encrypted packet. However, the inclusion of the device specific TOTP with the transaction request provides the benefit of allowing the authorization system 102 to validate the user device. This validation gives the authorization system 102 more certainty in determining the risk associated with the transaction request.

After receiving the transaction request from the second application 110A in step 308, the authorization system 102 in step 310 validates the transaction details, the user's transaction information, and the TOTP generated by the first application 108A on the user device 106A. The transaction details and the user's transaction information may be authorized and authenticated using existing authorization and authentication methods. However, the TOTP may also be validated by the authorization server 102 prior to authorizing the transaction. The TOTP may be validated using different methods. In some embodiments, the authorization server 102 may generate a key using the user's device specific TOTP provision combined with a timestamp to generate a key. The authorization system may then compare the generated key to the TOTP obtained from the user device 106A. If the two keys match, the transaction may be authorized. Other alternatives for authenticating a TOTP may be used as understood by experts in the field.

After validating the transaction and TOTP, the authorization system 102 authorizes the transaction request from the second application 110A on the user device 106A. The authorization system 102 authorizing the transaction request may include the step of actually conducting the transaction. In the case of a user making a purchase using a merchant application, the authorization system 102 may actually charge the user's account for the purchase made. In the case of a smart home system, the authorization system 102 may change a lightbulb turn on or off, or change the value of a thermostat.

The result of the transaction request is sent back to the second application 110A from the authorization system 102 in step 316. The result of the transaction may be simply a confirmation the transaction being completed or denied. Alternatively, in partially approved transactions, the response from the authorization system 102 to the second application 110A may include additional parameters. The result of this transaction request may be shown to the user after the transaction response is received from the authorization server 102.

A non-limiting example of the system described in FIG. 1 is a shopping ecosystem where the authorization system 102 is a bank (e.g., Chase, Bank of America, Wells Fargo), the first application 108A is the bank's app, and the second application 110A is a merchant app (e.g. Amazon, eBay, Venmo). Suppose a user has an existing account with the bank. In normal transactions, the user would provide his credit card or bank information to the merchant, and the merchant would send that information to the bank to authorize the transaction. This transaction is authorized primarily based on the credit card information provided (e.g., credit card number, zip code, security code). Now, however, when the user download's the bank's app, the user is prompted for authentication (e.g., username and password), and the bank's authorization system provides the bank app with a TOTP provision. The user may then identify the merchants he would like to authorize to use the TOTP security feature. When the user completes shopping on their phone and goes to checkout, the merchant's app will request a TOTP from the bank's app. The merchant's app will then send the transaction information along with the TOTP obtained from the bank's app. When the bank's authorization server receives the transaction request, the bank may generate its own TOTP and compare it to the received TOTP, and verify the validity of the transaction. The bank may have additional certainty that the transaction request came from a device owned by the user, thereby reducing the risk of a fraudulent transaction. Finally, the bank's authorization server will respond to the merchant's app authorizing or declining the transaction.

The flowchart and block diagrams in the figures illustrate examples of the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
receiving, at a server, an authorization request from a first application stored on a user device, the first application being associated with a third party;
wherein the authorization request comprises a time-based one-time password;
determining whether the time-based one-time password is associated with a time-based one-time password provision previously transmitted to a second application stored on the user device;
wherein the second application is associated with an account of a user of the user device; and
authorizing a transaction between the account of the user and the third-party, in response to determining that the time-based one-time password is associated with the time-based one-time password provision.

2. The method of claim 1, wherein the authorization request comprises a first authorization request, the time-based one-time password comprises a first time-based one-time password, and the transaction comprises a first transaction, and further comprising:
receiving a second transaction request from a third application stored on the user device, the third application being associated with a fourth party;
wherein the second transaction request includes at least a second time-based one-time password generated using the time-based one-time password provision and obtained from the second application;
determining whether the second time-based one-time password is associated with the time-based one-time password provision; and
authorizing a second transaction between the account of the user and the fourth party in response to determining that the second time-based one-time password is associated with the time-based one-time password provision.

3. The method of claim 1, wherein the authorization request comprises a first authorization request, the time-based one-time password comprises a first time-based one-time password, and the transaction comprises a first transaction, and further comprising:
receiving a second authorization request from the first application;
wherein the second authorization request includes at least a second time-based one-time password generated using the time-based one-time password provision and obtained from the second application;
determining whether the second time-based one-time password is associated with the time-based one-time password provision;
authorizing a second transaction between the account of the user and the third party in response to determining that the second time-based one-time password is associated with the time-based one-time password provision.

4. The method of claim 1, further comprising, prior to receiving the authorization request:
receiving an authentication request from the second application stored on the user device;
authenticating the user of the user device in response to receiving the authentication request;
determining the time-based one-time password provision; and
transmitting the time-based one-time password provision to the second application.

5. The method of claim 4, wherein the authentication request from the second application includes a unique identifier that uniquely identifies the user device on which the second application is stored and wherein generating the time-based one-time password provision comprises generating the time-based one-time password provision using the unique identifier.

6. The method of claim 1, wherein the time-based one-time password provision expires after a period of time, and further comprising:
determining whether the time-based one-time password provision is expired; and
wherein authorizing the transaction comprises determining that the time-based one-time password provision is not expired.

7. The method of claim 1, wherein the time-based one-time password provision comprises a string of characters for use by an authorization system to associate the time-based one-time password with the time-based one-time password provision.

8. The method of claim 1, wherein the time-based one-time password provision comprises a hashed shared secret key.

9. The method of claim 1, wherein the time-based one-time password comprises a hash value generated using the time-based one-time password provision, a time identifier, and a time interval.

10. The method of claim 9, wherein a time interval comprises the period of time during which the time-based one-time password is valid for authenticating any transaction and wherein the period of time is less than one minute.

11. A computer configured to access a storage device, the computer comprising:
a processor; and
a non-transitory, computer-readable storage medium storing computer-readable instructions that when executed by the processor cause the computer to perform:
receiving an authorization request from a first application stored on a user device, the first application being associated with a third party;
wherein the authorization request includes at least a time-based one-time password generated using a time-based one-time password provision associated with a second application stored on the mobile device;
wherein the second application is associated with an account of a user of the mobile device;
determining whether the time-based one-time password provision used to generate the time-based one-time password is valid;
authorizing a transaction between the account of the user and the third-party, in response to determining that the time-based one-time password provision used to generate the time-based one-time password provision is valid;
transmitting a notification of the authorization of the transaction to the third party.

12. The system of claim 11, wherein the authorization request comprises a first authorization request, the time-based one-time password comprises a first time-based one-time password, and the transaction comprises a first transaction, and wherein the computer-readable instructions, when executed by the processor, cause the computer to further perform:
receiving a second authorization request from a third application stored on the user device, the third application being associated with a fourth party;
wherein the second authorization request includes at least a second time-based one-time password generated using the time-based one-time password provision and originating from the second application;
determining whether the second time-based one-time password is associated with the time-based one-time password provision; and
authorizing a second transaction between the account of the user and the fourth party in response to determining that the second time-based one-time password is associated with the time-based one-time password provision.

13. The system of claim 11, wherein the authorization request comprises a first authorization request, the time-based one-time password comprises a first time-based one-time password, and the transaction comprises a first transaction, and wherein the computer-readable instructions, when executed by the processor, cause the computer to further perform:
receiving a second authorization request from the first application;
wherein the second authorization request includes at least a second time-based one-time password generated using the time-based one-time password provision and originating from the second application;
determining whether the second time-based one-time password is associated with the time-based one-time password provision;
authorizing a second transaction between the account of the user and the third party in response to determining that the second time-based one-time password is associated with the time-based one-time password provision.

14. The system of claim 12, wherein the computer-readable instructions, when executed by the processor, cause the computer to further perform, prior to receiving the second authorization request:
receiving an authentication request from the second application stored on the user device;
authenticating the user of the user device in response to receiving the authentication request;
determining the time-based one-time password provision;
transmitting the time-based one-time password provision to the user device.

15. The method of claim 14, wherein the authentication request from the second application includes a unique identifier that uniquely identifies the user device on which the second application is stored and wherein generating the time-based one-time password provision comprises generating the time-based one-time password provision using the unique identifier.

16. The system of claim 11, wherein the time-based one-time password provision comprises a string of characters that can be used by an authorization system to associate the time-based one-time password with the time-based one-time password provision.

17. The system of claim 11, wherein the time-based one-time password provision comprises a hashed shared secret key.

18. The system of claim 11, wherein the time-based one-time password comprises a hash value generated using the time-based one-time password provision, a time identifier, and a time interval.

19. The system of claim 18, wherein the time interval comprises the period of time during which the time-based one-time password is valid for authenticating any transaction and wherein the period of time is less than one minute.

20. A computer program product comprising:
a computer readable storage medium having computer readable program code embodied therewith, the computer readable program code comprising:
computer-readable program code configured to receive an authentication request from a second application stored on a user device;
computer-readable program code configured to authenticate a user of the user device in response to receiving the authentication request;
computer-readable program code configured to determine a time-based one-time password provision;
wherein the time-based one-time password provision comprises a string of characters that can be used by an authorization system to associate the time-based one-time password with the time-based one-time password provision
computer-readable program code configured to transmit the time-based one-time password provision to the user device;
computer-readable program code configured to receive an authorization request from a first application stored on a user device, the first application being associated with a third party;
wherein the authorization request includes at least a time-based one-time password generated using the time-based one-time password provision associated with the second application stored on the mobile device, a time identifier, and a time interval;
wherein the time interval comprises the period of time during which the time-based one-time password is valid for authenticating any transaction and wherein the period of time is less than one minute;
wherein the second application is associated with an account of a user of the mobile device;
computer-readable program code configured to determine whether the time-based one-time password provision used to generate the time-based one-time password is valid;
computer-readable program code configured to authorize a transaction between the account of the user and the third-party, in response to determining that the time-based one-time password provision used to generate the time-based one-time password provision is valid; and
computer-readable program code configured to determine transmit a notification of the authorization of the transaction to the third party.
